(19) United States
(12) Patent Application Publication
(10) Pub. No.: US 2013/0298018 A1
(43) Pub. Date: Nov. 7, 2013

(54) USING SOFTWARE INTERACTION INFORMATION

(71) Applicant: SCHLUMBERGER TECHNOLOGY CORPORATION, (US)

(72) Inventors: Ahmed Adnan Aqrawi, Stavanger (NO); David Sundi Barka, Hundvaag (NO); Glen Lillehammer, Hafrsfjord (NO); Erik Monsen, Hafrsfjord (NO)

(73) Assignee: SCHLUMBERGER TECHNOLOGY CORPORATION, Sugar Land, TX (US)

(21) Appl. No.: 13/732,349

(22) Filed: Dec. 31, 2012

Related U.S. Application Data
(60) Provisional application No. 61/642,735, filed on May 4, 2012.

(51) Int. Cl. G06F 3/048

(52) U.S. Cl. CPC G06F 3/048
USPC 715/704

(57) ABSTRACT

Example embodiments of the present disclosure include one or more of a method, computing device, computer-readable medium, and system for using software interaction information. An example embodiment of a method may include providing a domain object using software operating on a computing device; and storing, in an interaction object provided by the software, user interaction information related to a user interaction relating to the domain object. The user interaction information may be analyzed, and feedback may be provided to a user based upon analyzing the user interaction information.

### CROSS-REFERENCE TO RELATED APPLICATION

This application claims the benefit of U.S. Provisional Patent Application 61/642,735 filed 4 May 2012 entitled “ANALYZING USER INTERACTION WITH SOFTWARE” the entirety of which is hereby incorporated in its entirety.

### BACKGROUND

Certain software may record or analyze user interaction with respect to a computer system (e.g., recording user interaction with respect to all software executing on a computer system). However, such third party software might track interactions in a proprietary format that cannot be re-used by the tracked software. Furthermore, the foregoing software might not track all interactions, but rather just a portion of selected actions. For example, certain interaction tracking software may be external (i.e., not native) with respect to the software that is being tracked. As a result, such external interaction tracking software cannot fully track certain interaction information.

There is a need for user interaction analysis software that uses oil and gas software objects, including, without limitation objects related to geology and geophysics (“G&G”) software. An example of G&G software includes, without limitation, SCHLUMBERGER's® PETREL® software (referred to herein as “PETREL”). Although certain embodiments may be explained with reference to PETREL® software, it should be understood that the teachings of the present disclosure may be applied to other types of oil and gas software, including, without limitation, drilling software, oilfield management software, wellbore software, reservoir simulation software, and/or exploration software.

### SUMMARY

An example embodiment of the present disclosure may include a method, computing device, computer-readable media, and/or system for using an interaction object with software, including, without limitation, oil and gas software. An example embodiment of a method may include providing a domain object using software operating on a computing device; and storing, in an interaction object provided by the software, user interaction information related to a user interaction relating to the domain object. The user interaction information may be analyzed, and feedback may be provided to a user based upon analyzing the user interaction information.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Implementations of various technologies will hereafter be described with reference to the accompanying drawings. It should be understood, however, that the accompanying drawings illustrate the various implementations described herein and are not meant to limit the scope of various technologies described herein.

FIG. 1 illustrates an example system that includes various components for simulating a geologic environment.

FIG. 2 illustrates an example interaction module according to an embodiment of the present disclosure.

FIG. 3 illustrates an example method of using an interaction object according to an embodiment of the present disclosure.

FIG. 4 illustrates another example method of using an interaction object according to an embodiment of the present disclosure.

FIG. 5 illustrates a computer system that may embody an implementation of various technologies and techniques described herein.

### DETAILED DESCRIPTION

An example embodiment of the present disclosure may be used to analyze a user's interaction with software. Although the present disclosure describes example embodiments in the context of oil and gas software, the teachings of this disclosure may be applied to any type of software.

According to an example embodiment, seismic interpretation may be performed using oil and gas software such as the PETREL® seismic to simulation software framework (Schlumberger Limited, Houston, Tex.), which includes various features to perform attribute analyses (e.g., with respect to a 3D seismic cube, a 2D seismic line, etc.). While the PETREL® seismic to simulation software framework is mentioned, other types of software, frameworks, etc., may be employed for related purposes, such as attribute analyses.

An embodiment of the present disclosure may include software that tracks, records, and/or analyzes input devices, processes, tools, and command interactions related to software. An example embodiment of the present disclosure may be used in a variety of contexts, including, without limitation, one or more of the following: (i) support and/or training; (ii) artificial intelligence, and/or (iii) usability testing. Various embodiments of the present disclosure are described generally below, and then described in more detail further below.

Support and Training:

According to an example embodiment, a first user can perform one or more interactions (e.g., user interactions) with respect to software executing on a first computing device. The actions may be recorded to an interaction object so that results of such actions may be viewed by a second user on a second computing device. The first and second user may either be the same user or different users. Likewise, the first and second machine may be the same computing device or different computing devices.

As an example, a first user may perform actions on a first computing device with respect to host software (e.g., the first user may perform one or more steps of a workflow). The second user may then view a series of screenshots or a movie of the actions performed. The screenshots or movie may be produced by information recorded in an interaction object created on the first computing device at the time the first user performed the actions. In an example embodiment, the screenshots or movies may include additional information to enable a viewer to better understand the interaction (e.g., certain portions of a user interface may be highlighted and/or annotated, input device trails may be shown to track the movement of an input device, etc.). In another example embodiment, an instance of the host software executing on the second computer can actually perform one or more interactions in the host software based upon at least a portion of interaction information stored in the interaction object.

Artificial Intelligence:

Another example embodiment of the present disclosure may be used to provide software with “artificial intelligence” by collecting information about the user's actions in an object, analyzing the user's actions to identify one or more user interaction habits or patterns, and then providing feedback to the user based upon the analyzing (e.g., adapting the host software to the user's habits in a way that helps the user become more efficient).

Usability Testing:

In yet another example embodiment of the present disclosure, an object that records user interactions may be analyzed to produce one or more metrics that may be used to determine software “usability.”

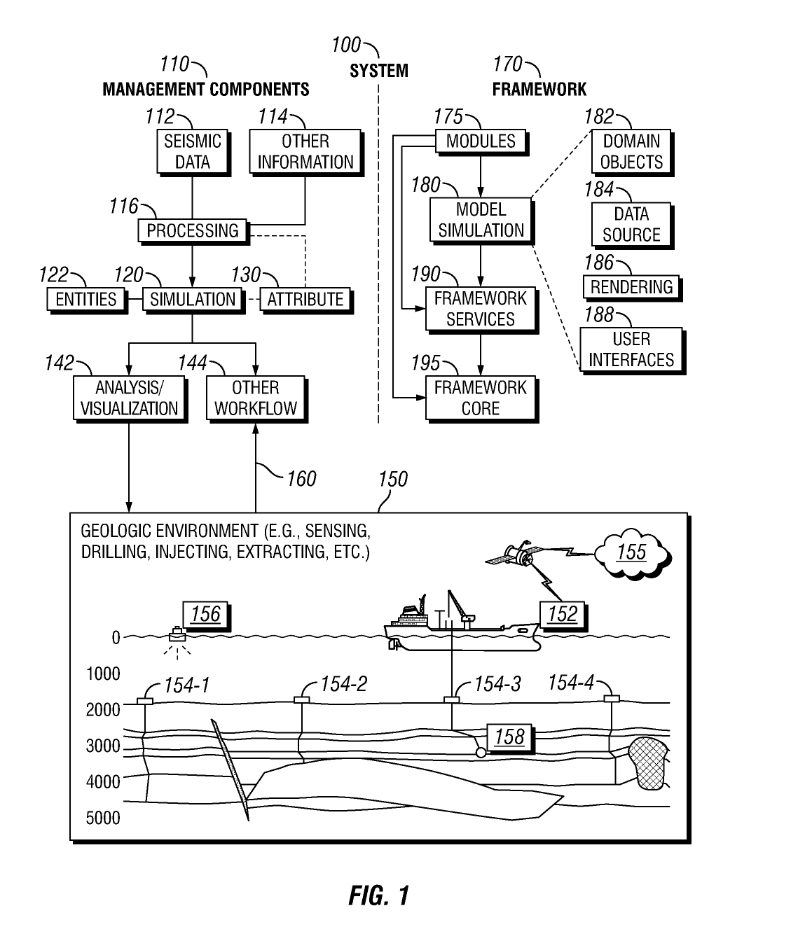

FIG. 1 shows an example of a system 100 that includes various management components 110 to manage various aspects of a geologic environment 150 (e.g., an environment that includes a sedimentary basin) as well as an example of a framework 170. In the example of FIG. 1, the components may be or include one or more modules. As to the management components 110, one or more of these components may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, geobodies, etc. In the system 100, the entities 122 can include virtual representations of actual physical entities that are reconstructed for purposes of simulation. The entities 122 may include entities based on data acquired via sensing, observation, interpretation, etc. (e.g., the seismic data 112 and other information 114).

In an example embodiment, the simulation component 120 may rely on a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data, geobody classes may define objects for representing geobodies based on seismic data, etc. As an example, an interpretation process that includes generation of one or more seismic attributes may provide for definition of a geobody using one or more classes. Such a process may occur via interaction (e.g., user interaction), semi-automatically or automatically (e.g., via a feature extraction process based at least in part on one or more seismic attributes).

In the example of FIG. 1, the simulation component 120 may process information to conform to one or more attributes specified by the attribute component 130, which may include a library of attributes. Such processing may occur prior to input to the simulation component 120. Alternatively, or in addition, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results, attributes, etc. In an example embodiment, output from the simulation component 120, the attribute component 130 or one or more other components may be input to one or more other workflows, as indicated by a workflow component 144 (e.g., for triggering another process).

In an example embodiment, the management components 110 may include features of a commercially available simulation framework such as the PETREL® seismic to simulation software framework. The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components (e.g., or modules) may be implemented as add-ons (or plug-ins) that conform to and operate according to specifications of a framework environment (e.g., according to application programming interface (API) specifications, etc.).

FIG. 1 also shows, as an example, the framework 170, which includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization. Such a model may include one or more grids (e.g., that represent a geologic environment).

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

In the example of FIG. 1, the domain objects 182 can include entity objects, property objects and optionally other objects related to oilfield software (e.g., geology, geophysics, drilling, reservoir simulation, wellbore, economics, oilfield management, flow simulation, etc.). Entity objects may be used to geometrically represent wells, surfaces, reservoirs, geobodies, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, including, without limitation, physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 158, which may be equipment to drill, acquire information, assist with resource recovery, etc. Other equipment 156 may be located remote from a well site and include sensing, detecting, emitting or other circuitry. Such equipment may include storage and communication circuitry to store and to communicate data, instructions, etc. The geologic environment 150 also shows various wells (e.g., wellbores) 154-1, 154-2, 154-3 and 154-4. In the example of FIG. 1, the downhole equipment 158 may include a drill for drilling the well 154-3.

The framework 170 may provide for modeling the geologic environment 150 including the wells 154-1, 154-2, 154-3 and 154-4 as well as stratigraphic layers, lithologies, faults, etc. The framework 170 may create a model with one or more grids, for example, defined by nodes, where a numerical technique can be applied to relevant equations discretized according to at least one of the one or more grids. As an example, the framework 170 may provide for performing a simulation of phenomena associated with the geologic environment 150 using at least a portion of a grid. As to performing a simulation, such a simulation may include interpolating geological rock types, interpolating petrophysical properties, simulating fluid flow, or other calculating (e.g., or a combination of any of the foregoing).

Support and/or Training

According to an example embodiment, a system 100 (shown in FIG. 1) may enable user interaction and certain other functionality, including, without limitation, recording of interaction information to an object that is defined and/or instantiated by software related to the system 100. “Interaction,” as used in the present disclosure, includes, without limitation, “user interaction.”

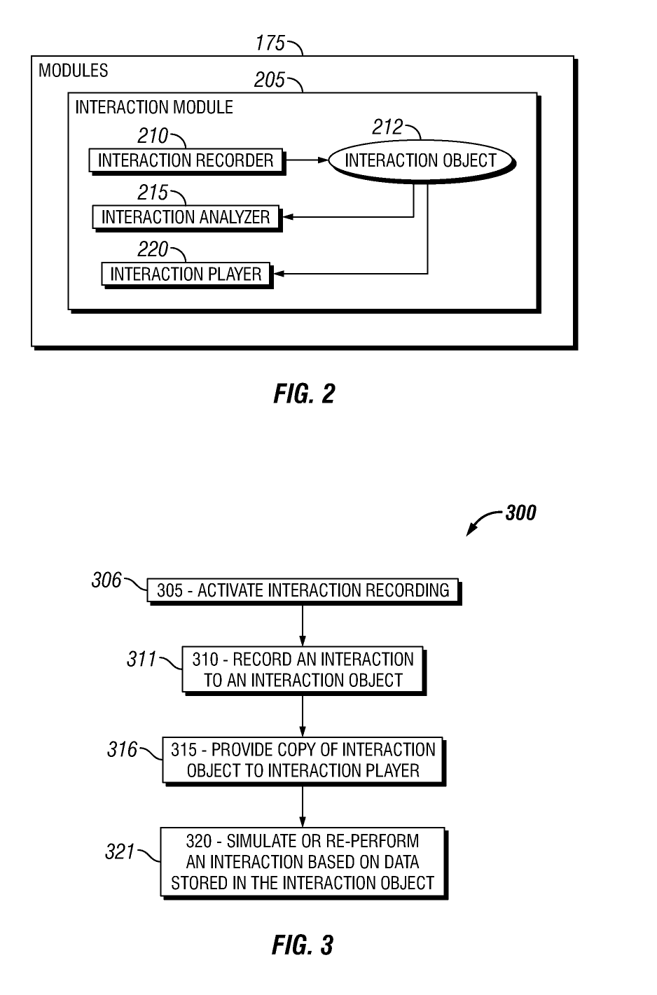

FIG. 2 shows an example embodiment of modules layer 175 (shown in FIG. 1) that includes an example interaction module 205. The interaction module 205 may include an interaction recorder 210 that is configured to record interactions with the system and/or software to an interaction object 212. An interaction analyzer 215 may be configured to analyze one or more interactions recorded by the interaction recorder 210 to the interaction object 212. An interaction player 220 may be adapted to play back and/or reproduce one or more interactions related to data stored in the interaction object 212. The software, which may include oil and gas software, may be referred to herein as “host software.” An “interaction object” may include interaction data relating to one or more interactions with various portions of the software, including, without limitation, one or more user interface elements. Furthermore, the interaction object may include one or more domain objects, and optionally may include information about interactions relating to such domain objects.

FIG. 3 shows an example embodiment of a method 300 for providing support and/or training in association with various computer-readable media (CRM) blocks 306, 311, 316, and 321. Host software may activate interaction recording at block 305 (e.g., initiated by a user or automatically initiated by the host software). A process in the host software, such as the interaction recorder 210 shown in FIG. 2, may gather and store information related to interaction with the host software to an interaction object at block 310 (e.g., interaction object 212 shown in FIG. 2). At block 315, a copy of the interaction object may be provided to an interaction player (e.g., interaction player 220 shown in FIG. 2) that visualizes, simulates, or re-performs an interaction based on interaction information stored in the interaction object at block 320. The interaction may be re-performed via the same computing device or host software instance upon which the interaction originally was performed, or via another computing device or host software.

An example scenario related to method 300 may include technical support. For example, a user might have one of the following user experiences (the following are merely examples—other user experiences are also possible):
A user might not know where to find a certain user interface element;
A user might not understand how to use certain host software functionality, or might not understand how such software functionality operates;
A user might experience a bug, error, catastrophic event, or crash in the host software; or
A user might receive an error message from the host software.

In response to a user experience (e.g., one or more of the above user experiences), a user might seek technical support. For example, the user might initiate a support ticket to internal or external technical support operations. According to an example embodiment, a user may transmit a copy of the interaction object to a second user (e.g., a member of the technical support staff or any other receiving user) or a computing system (e.g., a support database). The interaction object may be provided with (or in lieu of) project information or confidential or proprietary data. As an example, a copy of the interaction object may be electronically attached to a support ticket and/or stored to a support database.

Upon receiving the interaction object, a receiving user may use the interaction object with a second instance of the host software operating on a second computing device. The second computing device may be the same as the computing device that created the interaction object, or it may be a different computing device. In some example situations, the second instance of the host software may be the same instance of the host software that created the interaction object. The host software operating on the second computing device may include a process to retrieve information from the interaction object and visualize, simulate, and/or reproduce one or more interactions using the second computing device or second instance of the host software. The foregoing functionality may be implemented by the interaction player 220 shown in FIG. 2.

This enables a second user (e.g., a technical support staff member) to observe and/or recreate one or more interactions that were recorded to the interaction object (e.g., by viewing one or more of screenshots or a movie that was created based upon the interaction information). In an example embodiment, the interaction information and/or one or more domain objects related to the interaction object can be used to reproduce the interaction (e.g., re-perform one or more of the user interactions on the first or second computing device). Information recorded to the interaction object may include input device information (e.g., mouse movements, mouse clicks, keyboard keystrokes, voice commands, eye-tracking input, brain-wave readings, screen captures) and other user interaction and/or software execution information (e.g., commands or operations that are executed).

As may be seen from the foregoing description, a recipient of an interaction object (e.g., a technical support staff member) may use the information in the interaction object to execute one or more previously-performed interactions in the same and/or a different instance of the host application. The ability to view actual interaction provides an interaction object recipient with an advantage over a support mechanism that merely provides static snapshots, after-the-fact execution information, and/or text-based error logs that only capture information about a software module or file that caused a crash.

According to another example embodiment, an interaction object may be used to provide internal and/or external training. For example, interactions of a first user of host software may be recorded to an interaction object, and the interaction object may be distributed to one or more host software users within an organization or external to the organization (e.g., in order to demonstrate and/or provide training or best practices information with respect to the host software).

### Artificial Intelligence (AI)

An embodiment of the present disclosure may record and/or analyze user interaction with respect to host software. This can enable host software developers to add intelligence to the host software. For example, a host software developer can add functionality that aids the user in performing a task. This may include, without limitation, recognizing interaction patterns. Once an interaction pattern is identified, the host software may dynamically adapt to assist a user. In an example embodiment, the host software may provide feedback to the user by correcting a user's behavior and/or interaction when a certain task is performed in a way that differs from predetermined user interaction information (e.g., predetermined user interaction information related to a predetermined behavior and/or interaction). In another example embodiment the host software may provide information to help the user achieve a task (e.g., provide information via a dialog box, an interactive guide such as a wizard, etc.).

The following paragraphs describe at least three examples of applying AI: single vs. multiple user analysis, adaptive UI, and machine learning.

Single Vs. Multiple User Analysis Example—Fault/Horizon Interpretation:

In a single user analysis example, as a user uses one or more fault interpretation tools in a host software, the host software can track the user's interactions and/or habits and provide a suggestion to improve user experience. The native ability to track interactions allows host software to recognize a goal that the user is trying to achieve. Contextual information, such as information about the active processes and data, can also provide hints as to what the user is trying to achieve. For example, if host software recognizes that the user is using an automated tool, but often deletes the results of the tool, then upon recognizing this pattern, the host software can suggest that the user use semi-automated picking tools instead.

In another example embodiment involving multiple users, interaction information stored in a plurality of interaction objects can be collectively analyzed. For example, if interaction patterns in recorded interaction data suggest that a plurality of users should perform a host software interaction in a certain manner, the host software can suggest to a user that deviates from a predetermined interaction information (e.g., a user whose interaction deviates from a number of other users, or a user whose interaction deviates from predetermined interaction). This could be applied to training and/or orienting users who are unfamiliar with the host software.

Adaptive UI Example: Seismic Attributes and Parameters:

A user may want to set seismic parameters as they work with interpretation tools (e.g., in the case of attributes). By recognizing interaction patterns (e.g., a user prefers to start with structural attributes, or a user prefers a certain filtering radius that is different from a predetermined default filtering radius). Host software can be adapted to detect such interaction patterns, and can adapt one or more default software behaviors to accommodate the user (e.g., set a default software behavior to accommodate the user's interaction patterns). In an example embodiment, the host software can suggest one or more similar seismic attributes when it recognizes a predetermined interaction pattern that suggests that the user is having trouble achieving desired results (e.g., the user repeats one or more actions with respect to one or more seismic parameters). According to an example embodiment, the host software can suggest alternative workflows for one or more selected attributes based on other interaction data that has been submitted to a knowledge management system. The knowledge management system may be a public or private “cloud”-based system that collects interaction data from one or more users.

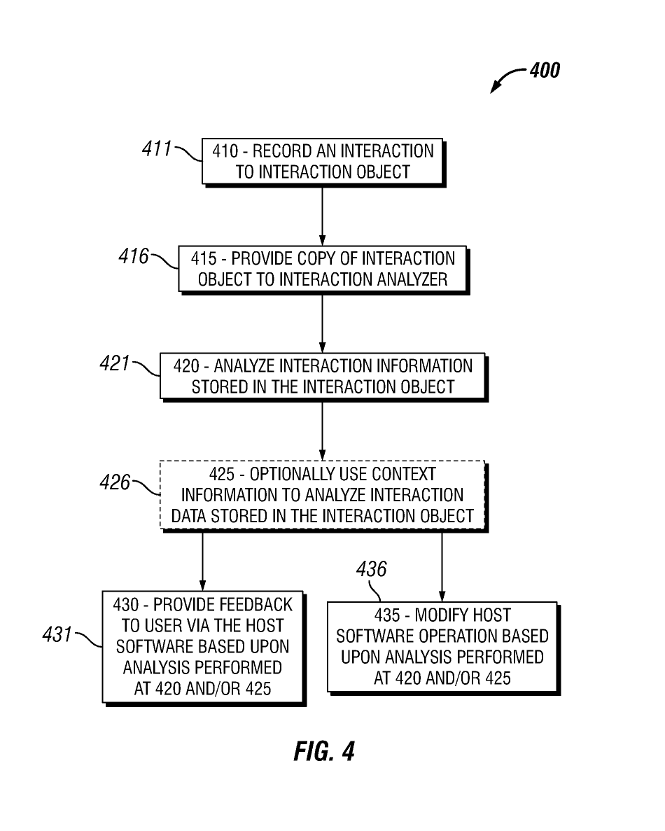

FIG. 4 shows an example method 400 for providing AI in association with various computer-readable media (CRM) blocks 411, 416, 421, 426, 431, and 436. Method 400 may begin at block 410, which includes recording an interaction to an interaction object. Context information about the object or about the interaction may also be stored to the interaction object at block 410. At block 415, a copy of the interaction object may be analyzed (e.g., by an interaction analyzer). The interaction information stored in the interaction may be analyzed at block 420. Optionally, at block 425, if the interaction object also includes context information, then such context information may also be analyzed (e.g., by the interaction analyzer or other component configured to analyze such information). The method 400 may proceed to either block 430 and/or block 435. At block 430, the host software may provide feedback to the user based upon the analysis performed at block 420 and/or block 425. Block 435 includes modifying host software operation based upon the analysis performed at block 420 and/or block 425.

### Usability Testing

Interaction information stored in an interaction object may be used for usability testing and analysis. An example of usability testing and analysis may be similar to an embodiment of a Software User Experience Analyzer (SUEA), as described below. The ability to track and record movement and events in software opens up a range of possibilities. This may include, without limitation, better communication of events between various parties, such as clients and support, commercialization and engineering, between clients, and training personnel and clients.

An example embodiment may include software that has hooks to one or more events (e.g., all events) within host software. As an example, such hooks may be enabled by a Software Development Kit (also referred to herein as an “SDK”), such as SCHLUMBERGER's OCEAN® framework environment (Schlumberger Limited, Houston, Tex.). The host software may record one or more of events in the system (e.g., all events). For example, an event may be recorded when one or more of the following occurs: a user selects a UI element (e.g., every time a UI element is selected), an active process changes, a process becomes active, and/or an input device changes (e.g., input device changes position). The foregoing are merely examples, and other events are within the scope of the present disclosure.

The recordings may be stored in a format to aid with the use of host software (e.g., to test usability of the host application). However enabling this interaction object and the ability to record actions, commands, and interactions is not limited to only usability testing.

Referring again to FIG. 4, according to an example embodiment, usability testing may follow method 400, and at block 435, one or more aspects of a UI may be modified based upon analysis performed at blocks 420 and/or 425.

Example embodiments described in the present disclosure may relate to one or more forms of usability testing. “Structured usability testing” may be used to describe usability testing where a tester follows a test script for repeatedly performing a task without any UI specific data. “Unstructured usability testing” may describe usability testing where a tester is asked to spend a predetermined amount of time using software to perform one or more specific workflows. “Formal testing” can be used to describe usability testing that is organized by a test administrator and involves multiple testers external to the development. A test report or summary of findings may be written and presented to a portfolio team and/or the development team. “Informal testing” can describe usability testing that is performed by a developer or a development team.

In an example use case involving structured and unstructured usability testing, information may be collected to facilitate software design. In such a use case, one or more of the following may be participants: a tester; one or more members of at least one of the following: a development team; a portfolio team, a commercialization team, and/or a usability team.

According to an example embodiment of unstructured usability testing, such testing might take place during an early or unstable development phase. During such a phase, a developer or development team might investigate usability of a tool or workflow under development. Furthermore, potentially alternative approaches or designs may be investigated. Recorded interaction stored in one or more interaction objects can be analyzed for certain interaction patterns that indicate a UI design issue.

In an example structured usability testing scenario, such testing might take place at a feature complete phase (e.g., end of development; mature/stable development phase). A test administrator may prepare test instructions and test scripts (structured testing), and present and/or coordinate the test. A user can execute one or more host software operations according to instructions while the host software gathers interaction information in an interaction object, as described herein. The interaction information in the interaction object may be shared as described to any example embodiment described herein. The test administrator may collect interaction information for analysis of user activity, and may produce statistics. As part of UI evaluation, a test administrator may search the interaction data for patterns that indicate one or more UI design issues.

With the unstructured and/or structured usability testing scenarios described above, once one or more issues have been identified, the UI design may be modified. Interaction with the modified UI may be recorded to one or more interaction objects, and such interaction information with the modified UI may be analyzed to evaluate any effects of the UI modifications.

An example embodiment of the present disclosure may include measuring learnability of a predetermined interaction. For example, usability testing may involve evaluating how long it takes a user to become familiar with an operation, and/or determine whether a user's efficiency improves once he/she has performed the operation a plurality of times. In such an evaluation, interaction information during a plurality of user operation performances may be recorded to one or more interaction objects. The interaction information may be analyzed to produce one or more metrics to determine whether the user's performance has improved (e.g., how long did it take for the user to perform the operation each time). Results of the analysis may be used to modify operation of the host software, including, without limitation, modifying the UI.

### Software User Experience Analyzer (SUEA)

Work in the area of user experience analysis may include evaluating software usability. In performing such work, several different types of software may be evaluated. Oil and gas software developers may use a standardized test environment for testing user experience. This may include setting up a machine for a test user where he/she may use software to perform certain predefined tasks. The test user's actions may be recorded during testing so that interactions may be analyzed using a software application according to an example embodiment of this disclosure. An example embodiment may be referred to herein as a Software User Experience Analyzer (SUEA).

An example embodiment of the present disclosure may be used to improve software usability. Although embodiments of the present disclosure are described in the context of oil and gas software, aspects of the present disclosure may also apply to desktop applications in general.

An example embodiment may provide an application that visualizes user workflows. Such workflows may be retrieved from a standardized file format. With this workflow visualization tool, an oil and gas software developer may assist usability testing by representing the data in various ways. For example, a user can choose to visualize one or more recorded interactions in a display, or play back such interactions sequentially (e.g., in a movie format). This allows a user to view oil and gas software interaction data, and may open up new possibilities for comparison studies.

When starting a SUEA, one or more notation files may be loaded. According to an example embodiment, the notation files may include text documents with information written in a specified format. The information may reflect one or more input events, e.g., mouse input, keyboard input, eye-tracking input, etc. In an example embodiment, software other than host software may be used to obtain information about user interaction with the host software (e.g., via a plug-in to the host software).

Once a notation file is loaded into a SUEA, certain information may be displayed. From here a user may be able to select one or more different views. Such views may provide a representation of usability data and may help in analyzing software usability.

As an example, a user of a SUEA may be able to view a “trace view.” That is, a user may be able to view a trace of a user's mouse movements, as well as other interaction events (e.g., mouse buttons clicks). For example, the trace may reflect the path of a user's interactions with software in various colors. In an example embodiment, the foregoing may all be shown in one window so that all recorded data for a session may be displayed in a single view. This may be used to assist a SUEA user to analyze overall movement and user performance with respect to an oil and gas application that is being analyzed. It can also be used to highlight a user's habits. In this view, as in other views, a SUEA may concurrently display multiple user interactions. This may include juxtaposing several oil and gas application users' interaction movements at the same time in various colors, and enabling a SUEA user to identify differentiating behavior from one user to the other.

According to an example embodiment, a SUEA may provide a second view that is similar to the trace view described above, but with a time element. This may allow a user of a SUEA to view mouse movement within analyzed oil and gas software as a movie where interaction movement, such as mouse cursor movement, may be drawn as a user interacts with the oil and gas software. Optionally, a SUEA may allow a user of the SUEA to choose a rate at which the foregoing information may be displayed. This may assist a SUEA user in identifying the order in which certain events occur, and may further enhance the analytical capabilities provided by a SUEA.

In an example embodiment, a SUEA may provide a view that represents a “region map.” In this view a SUEA user may view where one or more mouse events have occurred during a test session. As an example, a SUEA user may use this view to determine where a majority of events have occurred (e.g., mouse clicks). From this information, a SUEA user may be able to determine how much time is spent in certain dialogs and toolbars. This may provide a SUEA user with the ability to identify usability issues. As described above, a SUEA user may be able to use this view to compare one or more users' interaction with oil and gas software (e.g., showing all interaction at one time with each user's movements mapped in different colors). Also, as described above, a SUEA may display such information in a movie-format that indicates time.

An example SUEA may also provide a view that shows one or more statistics related to usability (referred to herein as a “statistical view”). This may include a chart view where the SUEA displays graphs of certain traits, such as travel length, amount of buttons pressed, errors occurred, etc. This view may be helpful for comparing between oil and gas software users given a task, in order to see the level of their knowledge of the subject at hand. This view may also be helpful in providing data that may be included in presentations for an audience, such as usability experts. Here again, a SUEA may be able to view data from all users that have taken a certain test, and may allow a SUEA user to customize the views to include the information that the user would like to see.

A SUEA according to an embodiment of the present disclosure can be used to help improve productivity and user experience in any software (e.g., identify inefficient UI interactions, such as mouse travel and/or keyboard usage). As software is being developed, newer versions of the application may be released (e.g., maybe with new UI or added features). A SUEA may help identify usability issues and give an indication of how well usability has progressed (i.e., monitor usability progress of a software over time).

### Computer System

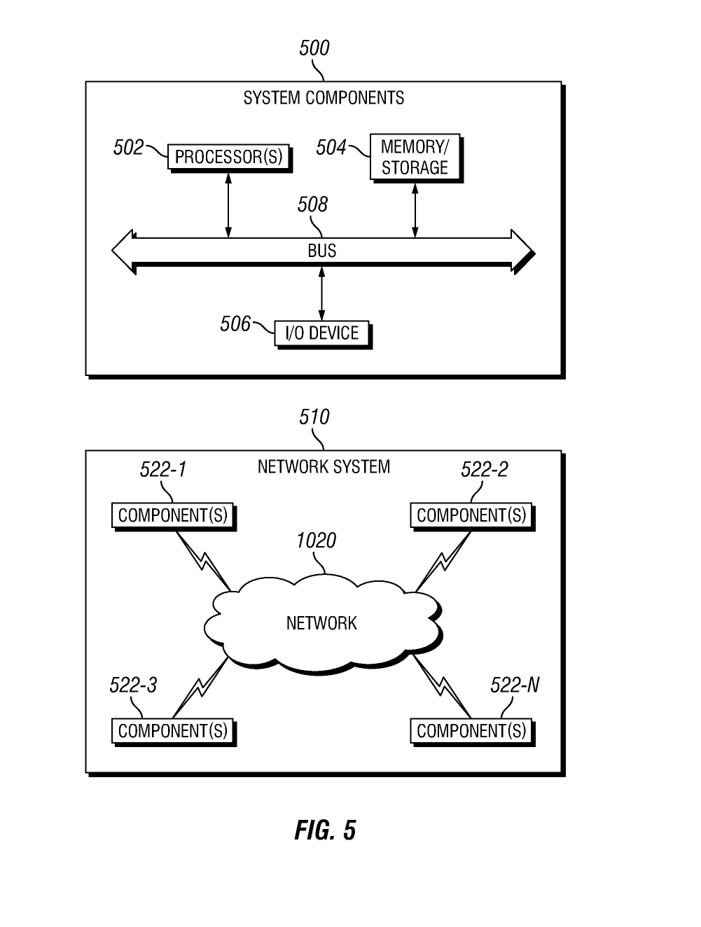

FIG. 5 shows components of an example of a computing system 500 and an example of a networked system 510. The system 500 includes one or more processors 502, memory and/or storage components 504, one or more input and/or output devices 506 and a bus 508. In an example embodiment, instructions may be stored in one or more computer-readable media (e.g., memory/storage components 504). Such instructions may be read by one or more processors (e.g., the processor(s) 502) via a communication bus (e.g., the bus 508), which may be wired or wireless. The one or more processors may execute such instructions to implement (wholly or in part) one or more attributes (e.g., as part of a method). A user may view output from and interact with a process via an I/O device (e.g., the device 506). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 510. The network system 510 includes components 522-1, 522-2, 522-3, . . . 522-N. For example, the components 522-1 may include the processor(s) 502 while the component(s) 522-3 may include memory accessible by the processor(s) 502. Further, the component(s) 502-2 may include an I/O device for display and optionally interaction with a method. The network may be or include the Internet, an intranet, a cellular network, a satellite network, etc.

### CONCLUSION

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method, comprising:
providing a domain object using software operating on a computing device;
storing, in an interaction object provided by the software, user interaction information related to a user interaction relating to the domain object;
analyzing the user interaction information; and
providing feedback to a user based upon analyzing the user interaction information.

2. The method of claim 1, wherein the user interaction information comprises context information related to the user interaction, and wherein analyzing the user interaction information comprises analyzing the context information.

3. The method of claim 1, wherein analyzing the user interaction information comprises comparing at least a portion of the user interaction information with a predetermined user interaction information.

4. The method of claim 3, wherein the predetermined user interaction information comprises second user interaction information related to a second user's interaction with a second software executing on a second computing device.

5. The method of claim 1, wherein providing feedback comprises modifying an operation of the software related to the user interaction based upon analyzing the user interaction information.

6. The method of claim 1, wherein analyzing the user interaction information comprises:
accessing the user interaction object by a second software executing on a second computing device; and
displaying, using the second software, at least a portion of the user interaction based on the user interaction information.

7. The method of claim 6, wherein analyzing the user interaction information comprises performing at least a portion of the user interaction using the second software.

8. The method of claim 6, wherein displaying at least a portion of the user interaction comprises displaying at least a portion of the user interaction along with additional information related to the user interaction.

9. The method of claim 8, wherein the displaying at least a portion of the user interaction comprises displaying at least a portion of input device movement related to the user interaction.

10. One or more computer-readable storage media comprising computer-executable instructions to instruct a computing system to:
provide a domain object;
store, in an interaction object, user interaction information related to a user interaction relating to the domain object;
analyze the user interaction information; and
provide feedback to a user based upon analyzing the user interaction information.

11. The computer-readable storage media of claim 10, wherein the user interaction information comprises context information related to the user interaction, and wherein analyzing the user interaction information comprises analyzing the context information.

12. The computer-readable storage media of claim 10, wherein instructions to instruct a computing system to analyze the user interaction information comprise instructions to instruct the computing system to compare at least a portion of the interaction information with predetermined user interaction information.

13. The computer-readable storage media of claim 10, further comprising computer-executable instructions to instruct the computing system to display at least a portion of the interaction along with additional information related to the interaction.

14. The computer-readable storage media of claim 10, further comprising computer-executable instructions to instruct the computing system to display at least a portion of input device movement related to the user interaction.

15. The computer-readable storage media of claim 10, further comprising computer-executable instructions to instruct the computing system to simulate or re-perform the user interaction using the user interaction information and the domain object.

16. A method, comprising:
providing a domain object using a first software operating on a first computing device;
storing, in an interaction object, user interaction information related to a user interaction with the first software operating on the first computing device;
displaying, using a second software operating on a second computing device, at least a portion of the user interaction.

17. The method of claim 16, further comprising, storing the interaction object to a database, and copying the interaction object from the database to the second software.

18. The method of claim 16, further comprising performing the user interaction using the second software, the user interaction object, and the domain object.

19. The method of claim 16, wherein displaying at least a portion of the user interaction comprises displaying at least a portion of input device movement related to the user interaction.

20. The method of claim 16, further comprising
analyzing the user interaction information; and
providing feedback to a user based upon analyzing the user interaction information.
